(19) United States
(12) Patent Application Publication
(10) Pub. No.: US 2016/0224654 A1
(43) Pub. Date: Aug. 4, 2016

(54) CLASSIFICATION DICTIONARY GENERATION APPARATUS, CLASSIFICATION DICTIONARY GENERATION METHOD, AND RECORDING MEDIUM

(71) Applicant: NEC CORPORATION, Minato-ku, Tokyo (JP)

(72) Inventors: Masaaki TSUCHIDA, Tokyo (JP); Kai ISHIKAWA, Tokyo (JP); Takashi ONISHI, Tokyo (JP)

(21) Appl. No.: 14/915,797

(22) PCT Filed: Sep. 17, 2014
(86) PCT No.: PCT/JP2014/004776

§ 371 Date: Mar. 1, 2016

(30) Foreign Application Priority Data
Sep. 18, 2013 (JP) 2013-192674

(51) Int. Cl. G06F 17/30; G06N 99/00

(52) U.S. Cl. CPC G06F 17/30598; G06F 17/30011; G06N 99/005

(57) ABSTRACT

A classification dictionary generation apparatus includes: a lower threshold storage unit that stores lower threshold information that determines a lower threshold of dimensional values of a classification dictionary for classifying a category of a document; and a control unit that generates the classification dictionary based on learning data whose category is known, wherein the control unit generates, based on the lower threshold information stored in the lower threshold storage unit, the classification dictionary in which all of the dimensional values are equal to or larger than the lower threshold.

### TECHNICAL FIELD

The present invention relates to a classification dictionary generation apparatus, a classification dictionary generation method and a recording medium for generating a dictionary for appropriately classifying a document.

### BACKGROUND ART

Governance of information security becomes more important. While management of information is a base of the governance of information security, it is difficult to manually read all of documents, and to appropriately manage all of the documents since the amount of document data generated every day grows steadily.

A basic process for appropriately managing the document is to classify each document into information of a management target or information of a non-management target (target category or non-target category). By generating a dictionary for use in classification (hereinafter, denoted as classification dictionary), it is possible to automatically classify the document using a computer. Meanwhile, it takes much man power and many costs to generate a dictionary that enables precise classification. Therefore, there is a need for a system which automatically generates the classification dictionary using a computer.

An example of the system which automatically generates the classification dictionary using the computer is described by NPL (non-patent literature) 1. The system described in the NPL 1, by using a set of documents to each of which a classification category is assigned in advance, learns a discriminant function (classification dictionary) used for classifying a document that has not been classified yet into a target category or a category other than the target category. Specifically, from a document included in a set of the documents to each of which the classification category is assigned in advance, the system extracts a word which belongs to a specific part of speech, and makes the extracted word corresponding to each dimension of a vector, and generates a vector whose dimension is set to be 1 if a word corresponding to the dimension appears in the document, and whose dimension is set to be 0 if a word corresponding to the dimension does not appear in the document. Next, by using a set of vectors which are generated based on each document, the system learns, by using the support vector machine, the discriminant function for classifying the target category into a positive example set and classifying the category other than the target category into a negative example set. Here, the support vector machine is a learning algorithm for obtaining an optimum separating hyper-plane by maximizing a margin when separating given data into the positive example set and the negative example set in a hyper space.

Moreover, as an example of the discriminant function, PTL (patent literature) 1 discloses a weight vector including weights which are respectively assigned to words (that is, dimensions of the vector) based on a specific part of speech or the like. Here, the weight has a positive or negative value. When a classification is performed a system described in PTL 1 extracts words from a target document and calculates a total of the weights which are assigned to the extracted words in a classification dictionary for a category of target as a score of the category. Furthermore, when the score is equal to or larger than a threshold value, the system classifies the extracted word into the category. That is, in the case that a word having a positive weight value appears, the score of the category of target is added, in the case that a word having a negative weight value appears, the score of the category of target is reduced.

### CITATION LIST

### Patent Literature

PTL 1: Japanese Patent Application Laid-Open Publication No. 2010-12521 Non Patent Literature
NPL 1: Hirotoshi TAIRA and Masahiko HARUNO, “Feature Selection in SVM Text Categorization”, Transaction of Information Processing Society of Japan, April 2000, Vol. 41, No. 4, pp. 1113-1123

### SUMMARY OF INVENTION

### Technical Problem

However, according to the systems described in the above-mentioned PTL 1 and NPL 1, in the case that, when classifying a document including information of a certain category (target category) into the target category, the document also includes many pieces of information (many words) that is not included in the target category, and the score which is the total of the weights of words appearing in the document tends to have a smaller value. The reason is that, in the above case, there are many words each of which has a negative weight. Accordingly, there is an issue in that the systems described in the PTL 1 and the NPL 1, if the amount of information belonging to the target category is less than the amount of information belonging to the other category, generates classification dictionaries for calculating lower the score representing probability of the category.

As a result, the systems described in the PTL 1 and the NPL 1 are not able to learn the discriminant function for predicting that the system is a positive example. Furthermore, the system described in the NPL 1 is not able to detect that, in the case of the above, there is a tendency that the score of the discriminant function (classification dictionary) becomes low.

An object of the present invention is to provide a dictionary generation apparatus, a classification dictionary generation method and a recording medium which, even if an amount of information corresponding to the target category is less than an amount of information corresponding to the non-target category, by solving the above-mentioned issue, generate a classification dictionary that calculates a score of the target category higher in comparison with a document not including information of the target category.

### Solution to Problem

A classification dictionary generation apparatus according to one exemplary aspect of the present invention includes: lower threshold storage means for storing lower threshold information that determines a lower threshold of dimensional values of a classification dictionary for classifying a category of a document; and control means for generating the classification dictionary based on learning data whose category is known. The control means generates, based on the lower threshold information stored in the lower threshold storage means, the classification dictionary in which all of the dimensional values are equal to or larger than the lower threshold.

A classification dictionary generation method according to one exemplary aspect of the present invention includes: storing lower threshold information that determines a lower threshold of dimensional values of a classification dictionary for classifying a category of a document; and generating the classification dictionary, in which all of the dimensional values are equal to or larger than the lower threshold, based on learning data whose category is known, and the lower threshold information stored.

A computer-readable recording medium according to one exemplary aspect of the present invention records a program for causing a computer to execute: a process of storing lower threshold information that determines a lower threshold of dimensional values of a classification dictionary for classifying a category of a document; and a process of generating the classification dictionary based on learning data whose category is known, wherein the process of generating the classification dictionary is a process of generating the classification dictionary, in which all of the dimensional values are equal to or larger than the lower threshold, based on the lower threshold information stored.

### Advantageous Effects of Invention

The present invention has an effect that, even if an amount of information corresponding to the target category is less than an amount of information corresponding to the non-target category, it is possible to generate the classification dictionary that calculates the score of the target category higher in comparison with the document not including information of the target category.

### BRIEF DESCRIPTION OF DRAWINGS

FIG. 1 is a diagram illustrating an example of a classification dictionary generation apparatus according to a first exemplary embodiment of the present invention.

FIG. 2 is a block diagram illustrating an example of a computer which realizes a configuration of the classification dictionary generation apparatus according to the first exemplary embodiment of the present invention.

FIG. 3 is a flowchart illustrating an example of an operation of the classification dictionary generation apparatus according to the first exemplary embodiment of the present invention.

FIG. 4 is a flowchart illustrating an example of an operation of a discriminant function calculation unit the classification dictionary generation apparatus according to the first exemplary embodiment of the present invention.

FIG. 5 is a diagram illustrating an example of configuration of learning data in the first exemplary embodiment of the present invention.

FIG. 6 is a diagram illustrating an example of configuration of a feature vector in the first exemplary embodiment of the present invention.

FIG. 7 is a diagram illustrating an example of configuration of lower threshold information in the first exemplary embodiment of the present invention.

FIG. 8 is a diagram illustrating an example of configuration of a discriminant function and a classification dictionary in the first exemplary embodiment of the present invention.

FIG. 9 is a diagram illustrating an example of a classification dictionary generation apparatus according to a second exemplary embodiment of the present invention.

FIG. 10 is a diagram illustrating an example of a classification dictionary generation apparatus according to a third exemplary embodiment of the present invention.

### DESCRIPTION OF EMBODIMENTS

### First Exemplary Embodiment

A classification dictionary generation apparatus in a first exemplary embodiment of the present invention calculates a discriminant function based on learning data whose category is known, and modifies a lower threshold in the calculated discriminant function and generates a classification dictionary for classifying a document into a category.

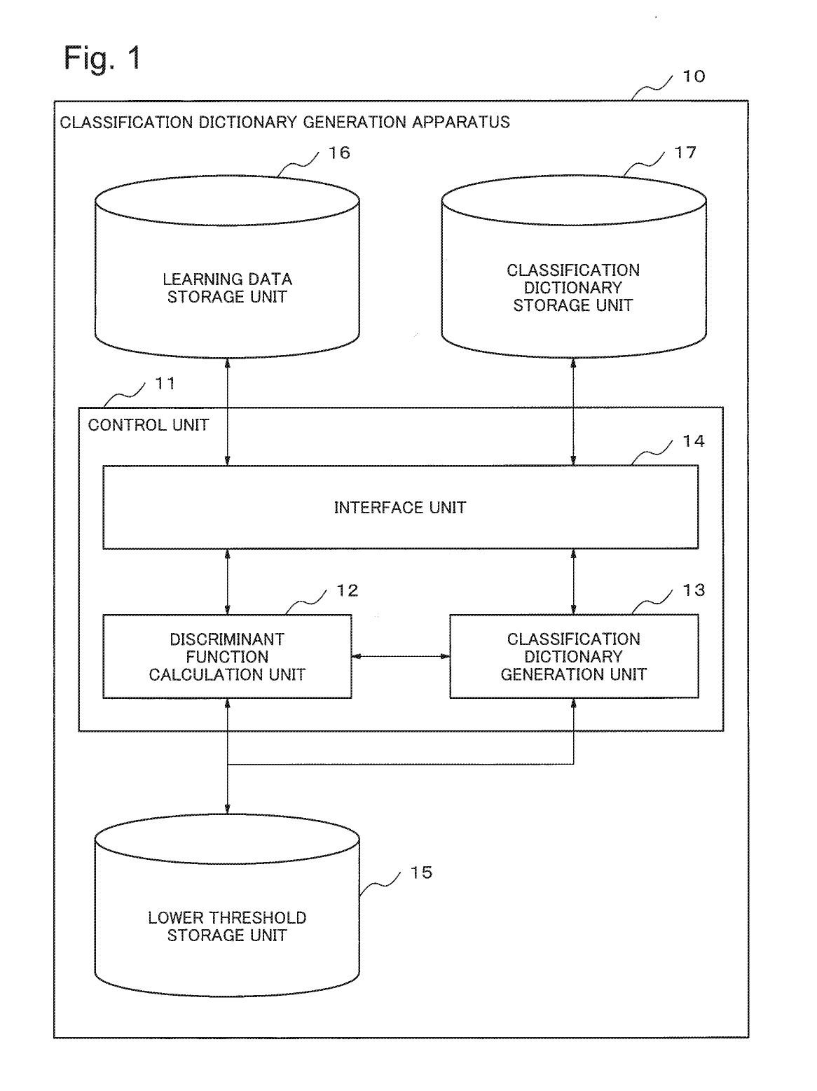

Firstly, the first exemplary embodiment of the present invention will be explained with reference to FIG. 1. Reference codes shown in FIG. 1 are assigned to respective components for the sake of convenience as an example helpful for understanding, and accordingly to assign the reference codes has no intention to generate any kinds of limitation.

FIG. 1 is a diagram illustrating an example of a classification dictionary generation apparatus 10 in the first exemplary embodiment of the present invention. As shown in FIG. 1, the classification dictionary generation apparatus 10 in the first exemplary embodiment of the present invention includes a control unit 11, a lower threshold storage unit 15, a learning data storage unit 16 and a classification dictionary storage unit 17. The control unit 11 includes a discriminant function calculation unit 12, a classification dictionary generation unit 13 and an interface unit 14.

The interface unit 14 reads the learning data which the learning data storage unit 16 stores, and outputs the learning data to the discriminant function calculation unit 12. Moreover, the interface unit 14 writes the calculated classification dictionary in the classification dictionary storage unit 17. The discriminant function calculation unit 12 calculates the discriminant function using the learning data. Here, the learning data is, for example, a set of documents to each of which category information is assigned. Moreover, the discriminant function is a function which, by using a set of documents to each of which a classification category is assigned in advance, classifies each document into a target category or a category other than the target category. An example of the discriminant function is a weight vector. The classification dictionary generation unit 13 generates the classification dictionary related to the target category. The classification dictionary generation unit 13 generates the classification dictionary, for example, by using the discriminant function based on lower threshold information.

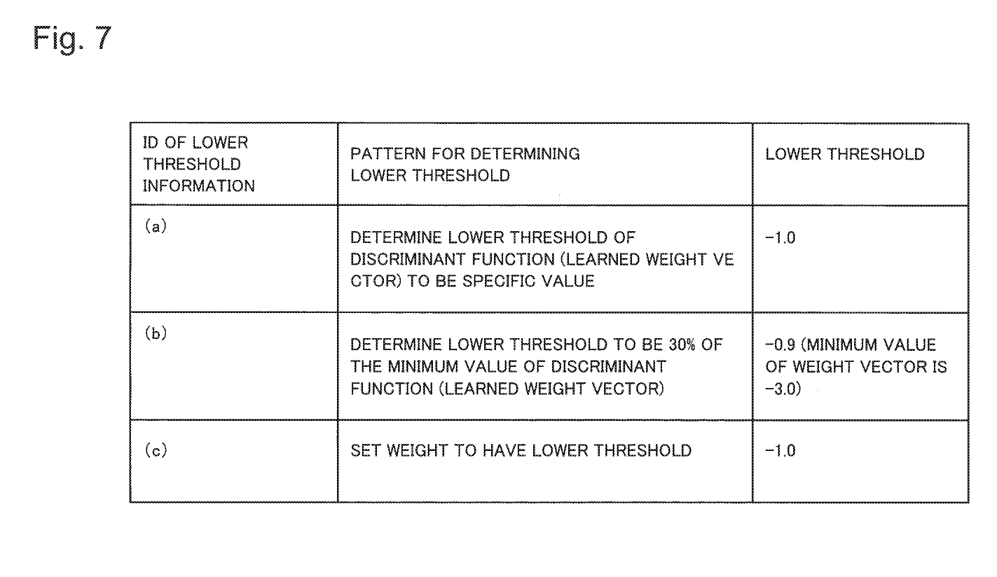

The lower threshold storage unit 15 stores the lower threshold information including the lower threshold. Details on the lower threshold information will be described later with reference to FIG. 7. The learning data storage unit 16 stores the learning data. The classification dictionary storage unit 17 stores the classification dictionary which is generated by the classification dictionary generation unit 13.

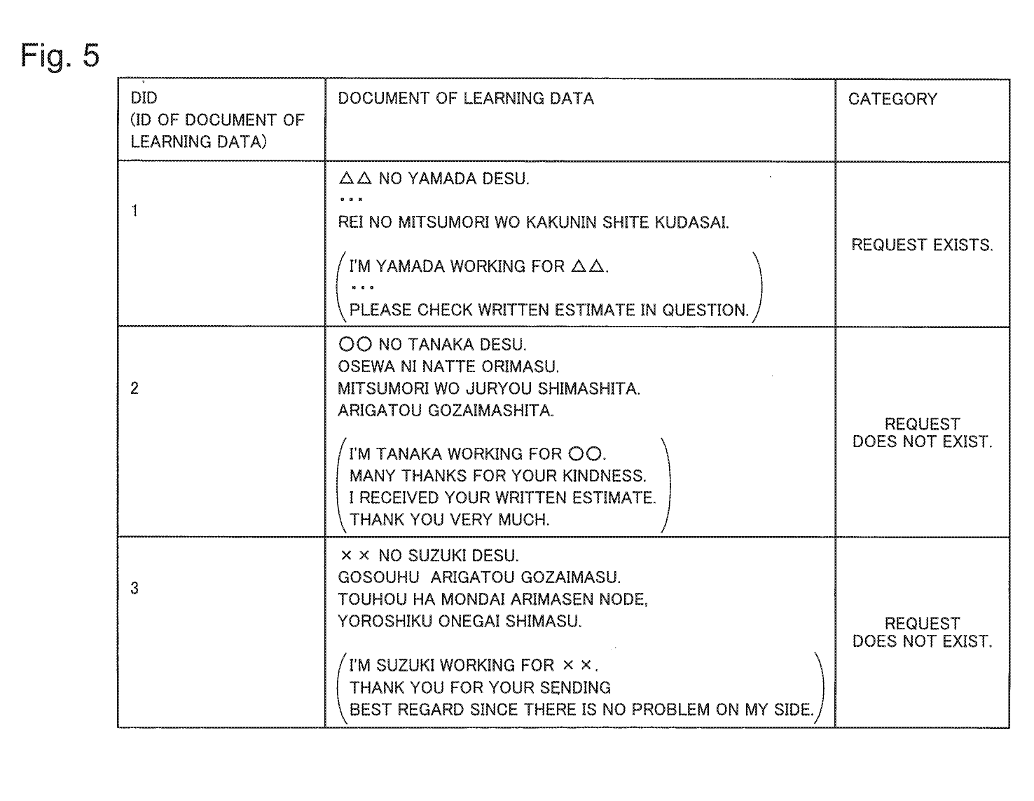

FIG. 5 is a diagram illustrating an example of configuration of the learning data which the learning data storage unit 16 stores. As shown in FIG. 5, the learning data is data which is obtained by associating “DID” which is ID of the document of the learning data, “document of learning data” which is the document itself of the learning data, and “category” which is the category information of the document of the learning data. As shown in FIG. 5, the learning data storage unit 16 stores the data associated with, for example, DID “2”, a document of learning data “∘∘ NO TANAKA DESU. OSEWA NI NATTE ORIMASU. MITSUMORI WO JURYOU SHIMASHITA. ARIGATOU GOZAIMASHITA. (I am TANAKA working for ∘∘. Many thanks for your kindness. I received your written estimate. Thank you very much.)”, and a category “request does not exist”. Here, a meaning of the request shown in FIG. 5 will be mentioned later.

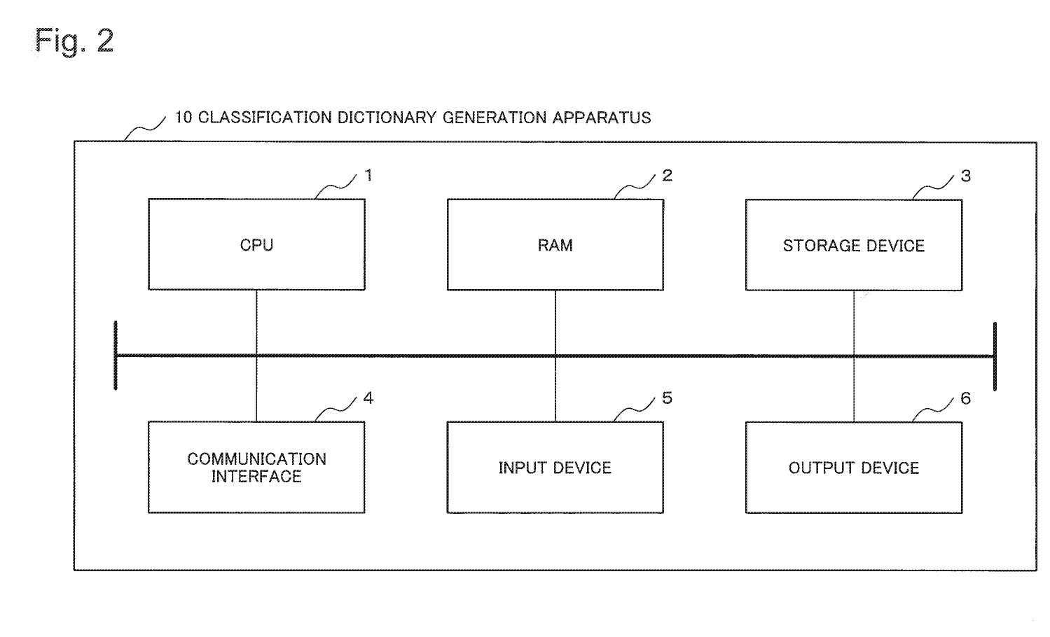

A computer which realizes the classification dictionary generation apparatus 10 of the first exemplary embodiment of the present invention will be explained with reference to FIG. 2.

FIG. 2 is a typical hardware configuration diagram of the classification dictionary generation apparatus 10 of the first exemplary embodiment of the present invention. As shown in FIG. 2, the classification dictionary generation apparatus 10 includes, for example, CPU (Central Processing Unit) 1, RAM (Random Access Memory) 2, a storage device 3, a communication interface 4, an input device 5, an output device 6 and the like.

The discriminant function calculation unit 12 and the classification dictionary generation unit 13 are realized by CPU 1 which executes a program loaded into a main storage device such as RAM 2. The interface unit 14 is realized, for example, by causing CPU 1 to execute an application program using functionality provided by an Operating System (OS) of CPU 1. The storage device 3 is, for example, a hard disc, a flash memory or the like. The storage device 3 functions as the lower threshold storage unit 15, the learning data storage unit 16 and the classification dictionary storage unit 17. Moreover, the storage device 3 stores the above-mentioned application program.

The communication interface 4 is connected with CPU 1 and is connected with a network or an external storage medium. An external data may be input into CPU 1 through the communication interface 4. The input device 5 is, for example, a key board or a touch panel. The output device 6 is, for example, a display. Here, the hardware configuration shown in FIG. 2 is a mere example, and each unit of the classification dictionary generation apparatus 10 shown in FIG. 1 may be configured of a separated logic circuit.

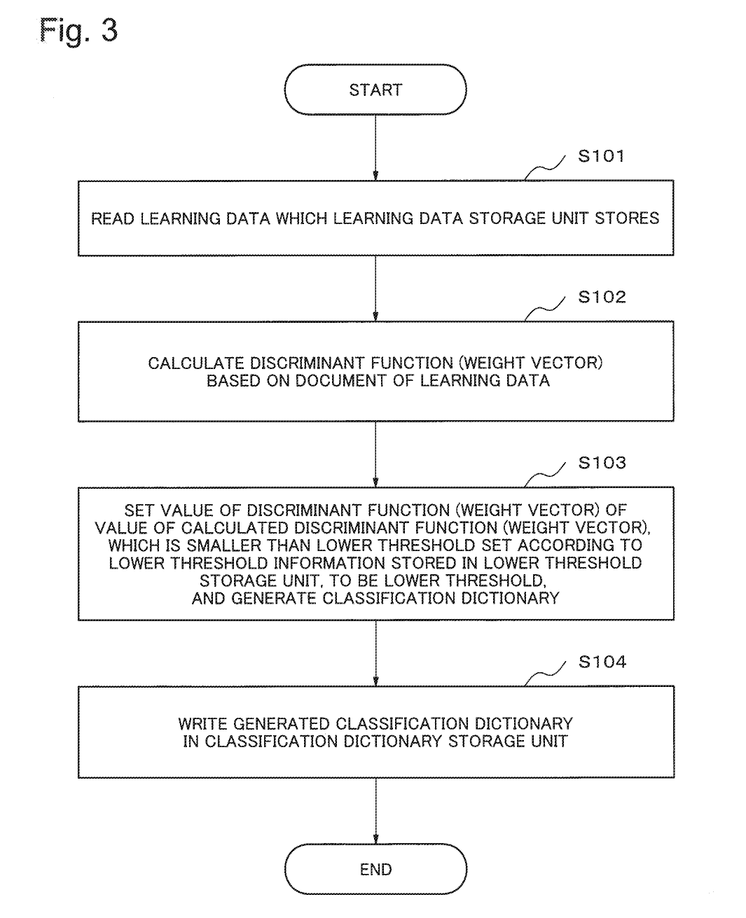

Next, an operation of the classification dictionary generation apparatus 10 in the first exemplary embodiment of the present invention will be explained with reference to FIGS. 3, 4, 6, 7 and 8. In this example, classification for detecting a document including a request requesting another party to do something, for example, a request for a reply to a mail or a request for an answer to a question, is taken into consideration. Therefore, it is assumed that the target category is “request exists” and the non-target category is “request does not exist”.

Here, classification carried out by the classification dictionary generation apparatus 10 is not limited to the above-mentioned classification. In order to consider classification for detecting whether a certain document is a sport newspaper or not, it may be assumed that the target category is “sport newspaper”, and the non-target category is “other than sport newspaper”. The classification dictionary generation apparatus 10 of the present invention generates a dictionary which carries out classification based on a category (target category) which is a target of carrying out classification and a non-target category other than the target category.

FIG. 3 is a flowchart illustrating the operation of the classification dictionary generation apparatus 10 of the first exemplary embodiment of the present invention. In FIG. 3, S101 to S104 indicate process steps in the example of the operation.

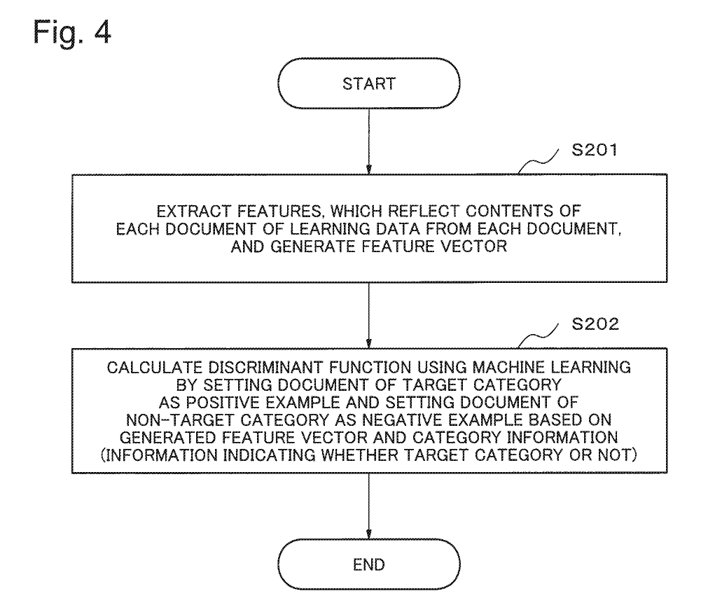

The interface unit 14 reads the learning data which the learning data storage unit 16 stores, and outputs the read learning data to the discriminant function calculation unit 12 (S101). Next, the discriminant function calculation unit 12 calculates the discriminant function based on the learning data which is read by the interface unit 14 (S102). A detailed operation of the discriminant function calculation unit 12 will be explained at a time of explaining a flowchart of FIG. 4.

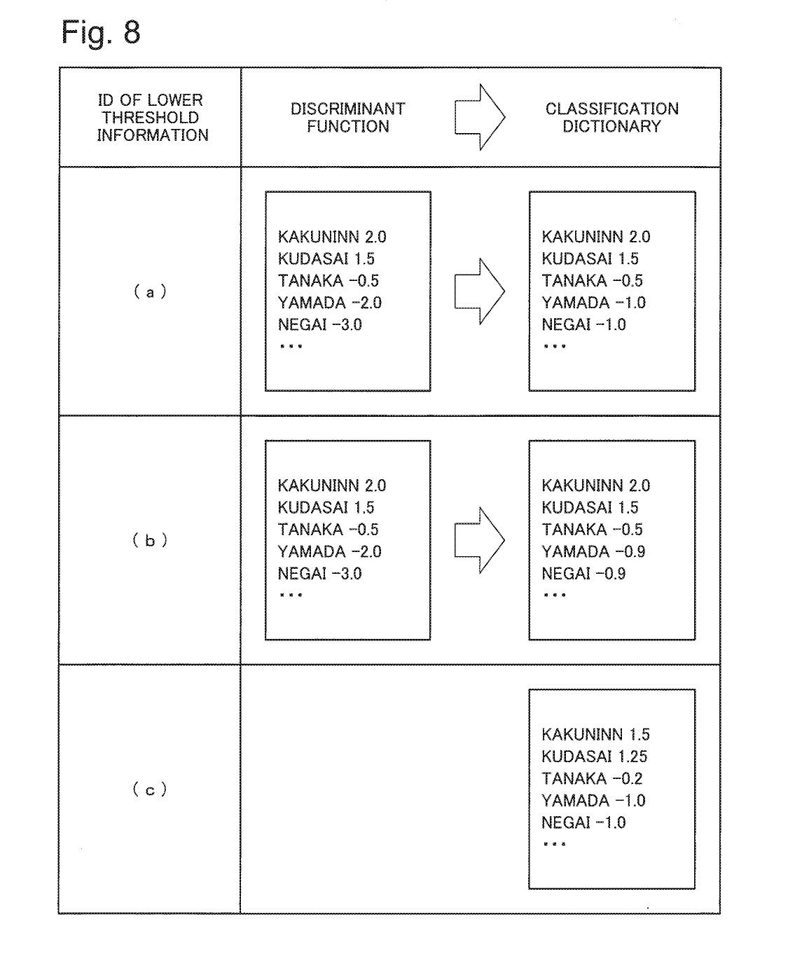

Next, the classification dictionary generation unit 13 converts the value of the calculated discrimination function (weight vector) to the lower threshold set according to the lower threshold information stored in the lower threshold storage unit 15 if the value of the calculated discrimination function (weight vector) is smaller than the lower threshold set according to the lower threshold information, and outputs the discrimination function (weight vector) whose value is converted (S103). A detailed operation of the classification dictionary generation unit 13 will be explained with reference to FIGS. 7 and 8.

Next, the interface unit 14 writes the classification dictionary, which the classification dictionary generation unit 13 generates, in the classification dictionary storage unit 17 (S104).

Next, FIG. 4 is a flowchart illustrating an operation of the discriminant function calculation unit 12 of the first exemplary embodiment of the present invention. In FIG. 4, S201 to S202 indicate process steps in an example of the operation.

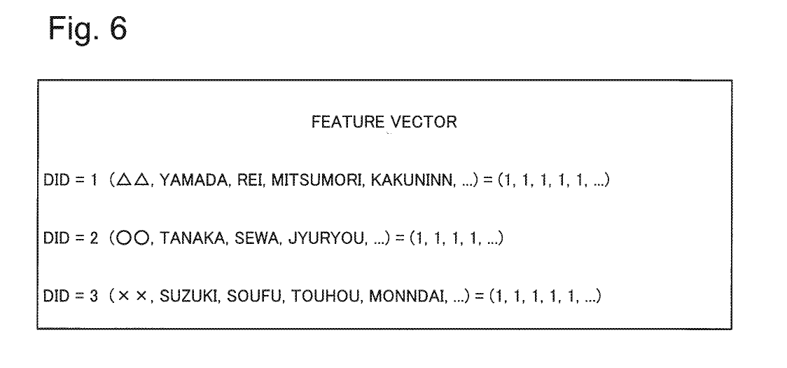

The discriminant function calculation unit 12 extracts features, which reflect contents of each document of the learning data read by the interface unit 14, from each the document. According to this example, the discriminant function calculation unit 12 extracts all of nouns, verbs and auxiliary verbs in the document. Then, the discriminant function calculation unit 12 generates a feature vector (S201). Here, detailed configuration of the feature vector will be explained with reference to FIG. 6.

FIG. 6 is a diagram illustrating an example of the configuration of the feature vector which the discriminant function calculation unit 12 calculates based on the learning data shown in FIG. 5. The feature vector in the example shown in FIG. 6 is a data row obtained by associating each word of a noun, a verb and an auxiliary verb which are extracted as a result of the morphological analysis carried out to the learning data by the discriminant function calculation unit 12, and “1” which is a dimensional value assigned to each word. Specifically, the feature vector in the case that DID is 1 (DID=1) is “ΔΔ, YAMADA, REI, MITSUMORI, KAKUNINN, . . . )=(1, 1, 1, 1, 1, . . . ).

That is, in this example, the features which are extracted when calculating the feature vector are the words of the noun, the verb and the auxiliary verb. Then, the discriminant function calculation unit 12 carries out the morphological analysis to the learning data to calculate the dimensional value of the word of each features (noun, verb and auxiliary verb) as “1”, and calculate the dimensional value of the word other than the features, for example, the dimensional value of a postpositional particle, an adjective, an adverb or the like as “0”.

Here, in the case of the feature vectors shown in FIG. 6, for simplifying the drawing, a feature vector element for the word whose dimensional value is “0”, that is, a feature vector element of the word other than the noun, the verb and the auxiliary verb in the learning data is not described (shown). Specifically, for example, description of postpositional particle “(NO, NI, WO, . . . )=(0, 0, 0, . . . )” is omitted from the feature vector of DID=2 as shown in FIG. 6. However, in reality, the feature vector including the dimension of “0” exists.

From the learning data which the interface unit 14 inputs, that is, from each document to which the category information is assigned, the discriminant function calculation unit 12 extracts the features which reflect the contents of each document (hereinafter, described as features), and calculates (generates) the feature vector. In addition to the word which appears in the document and which satisfies a predetermined condition, such as the noun, the verb and the auxiliary verb shown FIG. 6, the features may include a phrase which includes a plurality of words, a clause, a character substring, and a modification relation among two or more words or clauses, and the features are not limited there to.

Next, the discriminant function calculation unit 12 calculates the discriminant function using the machine learning by setting a document of the target category as a positive example and setting a document of the non-target category as a negative example based on the generated feature vector and the category information (information indicating whether the target category or not), (S202). As a specific method for calculating the discriminant function, for example, the calculation method which is described in NPL 1 may be used. For example, according to the calculation method which is described in NPL 1, the discriminant function is calculated by setting a value of the positive example as +1, and a value of the negative example as −1. As the machine learning, any method, may be used that learns the weight of each dimension of a vector using a set of vectors having the category as input.

As a typical example of the machine learning, for example, there are a logistic regression and a support vector machine are employed. In this example, the discriminant function calculation unit 12 uses the support vector machine as the machine learning to calculate the discriminant function. Since the method, with which the discriminant function calculation unit 12 calculates the discriminant function, is known, details of the operation thereof are omitted. The discriminant function which is calculated by the discriminant function calculation unit 12 is shown in FIG. 8.

Next, a detailed operation of the classification dictionary generation unit 13 will be explained with reference to FIGS. 7 and 8. Firstly, data configuration shown in FIGS. 7 and 8 will be explained.

FIG. 7 is a diagram illustrating an example of configuration of the lower threshold information which the lower threshold storage unit 15 stores. As shown in FIG. 7, the lower threshold information is data which is obtained by associating ID of the lower threshold information, a way (pattern) for determining the lower threshold, and the lower threshold. Specifically, in the case that ID of the lower threshold information is “(a)”, the pattern for determining the lower threshold is “to determine the lower threshold of the discriminant function (learned weight vector) to be a specific value”, and the lower threshold determined by this pattern is “−1.0”.

FIG. 8 is a diagram illustrating data of the discriminant function which the discriminant function calculation unit 12 calculates, and data of the classification dictionary which the classification dictionary generation unit 13 generates based on the discriminant function. Specifically, in the case that ID of the lower threshold information is “(a)”, that is, in the case that the pattern for determining the lower threshold is “to determine the lower threshold of the discriminant function (learned weight vector) to be the specific value”, and the data of the discriminant function is “KAKUNINN 2.0, KUDASAI 1.5, TANAKA −0.5, YAMADA −2.0, NEGAI −3.0, . . . ”, the data of the classification dictionary is “KAKUNINN 2.0, KUDASAI 1.5, TANAKA −0.5, YAMADA −1.0, NEGAI −1.0, . . . ”.

As shown in FIGS. 7 and 8, the classification dictionary generation unit 13 generates the classification dictionary in which, of the dimensions of the discrimination function calculated by the discrimination function calculation unit 12, the dimensional value corresponding to the non-target category (in this example, weight having a negative value) is equal to or larger than the lower threshold determined by the lower threshold information stored in the lower threshold storage unit 15. Here, the dimension of the discriminant function means the dimension of the vector.

As shown in FIGS. 7 and 8, the classification dictionary generation unit 13 generates the classification dictionary, for example, by using the pattern for determining the lower threshold which is specified by the lower threshold information having ID (a), that is, by using the pattern which is “to determine the lower threshold of the discriminant function to be the specific value”. The above-mentioned method is a method in which the lower threshold is determined firstly, and afterward the value of the discriminant function (weight of the weight vector), which is lower than the lower threshold, is converted into the lower threshold based on the discriminant function (weight vector) which the discriminant function calculation unit 12 acquires by using the machine learning. According to this example, since it is assumed that the lower threshold becomes −1.0, the lower threshold is −1.0 as shown in FIG. 7. Since, as shown in FIG. 8, in the case that ID of the lower threshold information is (a), the discriminant function is “KAKUNINN” 2.0, “KUDASAI” 1.5, “TANAKA” −0.5, “YAMADA” −2.0, “NEGAI” −3.0, . . . , the classification dictionary generation unit 13 converts every item, whose lower threshold is lower than −1.0, into −1.0. Specifically, as shown in FIG. 8, the classification dictionary generation unit 13 converts, for example, “YAMADA −2.0” of the discriminant function into “YAMADA −1.0”. As a result, the classification dictionary generation unit 13 generates the classification dictionary of “KAKUNINN 2.0, KUDASAI 1.5, TANAKA −0.5, YAMADA −1.0, NEGAI −1.0, . . . ”, in the case that ID of the lower threshold information is (a).

Next, as shown in FIG. 7, the classification dictionary generation unit 13 generates the classification dictionary by using the pattern for determining the lower threshold which is specified by the lower threshold information having ID (b), that is, by using the pattern which is “to determine the lower threshold to be 30% of the minimum value of the discriminant function”. This method is a method in which a ratio, which is larger than 0 and smaller than 1, is determined with respect to the minimum value (hereinafter, described as the minimum value) of the values of each discriminant function acquired by the discriminant function calculation unit 12 by using the machine learning. Subsequently, the lower threshold is determined by multiplying the minimum value by the ratio, and the value of the discriminant function, which is lower than the lower threshold, is converted to the lower threshold. In this example, the lower threshold is set to be 30% of the minimum value of the discriminant function.

Specifically, as shown in FIG. 8, the classification dictionary generation unit 13 selects the minimum value, for example, out of “KAKUNINN 2.0, KUDASAI 1.5, TANAKA −0.5, YAMADA −2.0, NEGAI −3.0, . . . ”, which is the discriminant function in the case that ID of the lower threshold information is (b), that is, selects the “NEGAI −3.0” in the case of this example, and calculates 30% of the minimum value, that is, −3.0×0.3 to acquire that the lower threshold is −0.9. Then, the classification dictionary generation unit 13 converts every item, whose lower threshold is lower than −0.9, into −0.9. As a result, the classification dictionary generation unit 13 generates the classification dictionary of “KAKUNINN 2.0, KUDASAI 1.5, TANAKA −0.5, YAMADA −0.9, NEGAI −0.9, . . . ” in the case that ID of the lower threshold information is (b).

Here, the pattern for determining the lower threshold of the lower threshold information is not limited to the pattern shown in FIG. 7. Specifically, in the case that ID of the lower threshold information is (a), the lower threshold may be −0.9, and in the case that ID of the lower threshold information is (b), the method for determining the lower threshold may be “33% of the minimum value of the discriminant function”.

Here, as shown in FIG. 7, an operation (generation method) of the classification dictionary, which is obtained by using the pattern for determining the lower threshold, that is specified by the lower threshold information having ID (c), that is, by using the pattern that is “to set the weight to have the lower threshold”, will be explained using a modified example of the first exemplary embodiment of the present invention.

Moreover, the classification dictionary generation unit 13 may automatically select one of the patterns (corresponding to IDs (a) to (c) of the lower threshold information) for determining the lower threshold of the lower threshold information shown in FIG. 7 to generate the classification dictionary, or may generate a classification dictionary in a state which is predetermined by a user.

By carrying out the above-mentioned processes, the operation of the classification dictionary generation apparatus 10 in the first exemplary embodiment of the present invention has been completed.

In the classification dictionary generation apparatus 10 of the first exemplary embodiment of the present invention, the learning data storage unit 16 stores the learning data. The interface unit 14 reads the learning data which the learning data storage unit 16 stores, and outputs the read learning data to the discriminant function calculation unit 12. The discriminant function calculation unit 12 calculates the discriminant function based on the learning data which is read by the interface unit 14. Then, the classification dictionary generation unit 13 generates the classification dictionary based on the discriminant function which the discriminant function calculation unit 12 calculates and the lower threshold information which the lower threshold storage unit 15 stores. The interface unit 14 writes the classification dictionary, which the classification dictionary generation unit 13 generates, in the classification dictionary storage unit 17. The classification dictionary storage unit 17 stores the output classification dictionary. Accordingly, even if the amount of the information corresponding to the target category is less than the amount of the information corresponding to the non-target category, it is possible for the classification dictionary generation apparatus 10 to generate the classification dictionary which calculates the score of the target category higher in comparison with the document not including information of the target category.

### Second Exemplary Embodiment

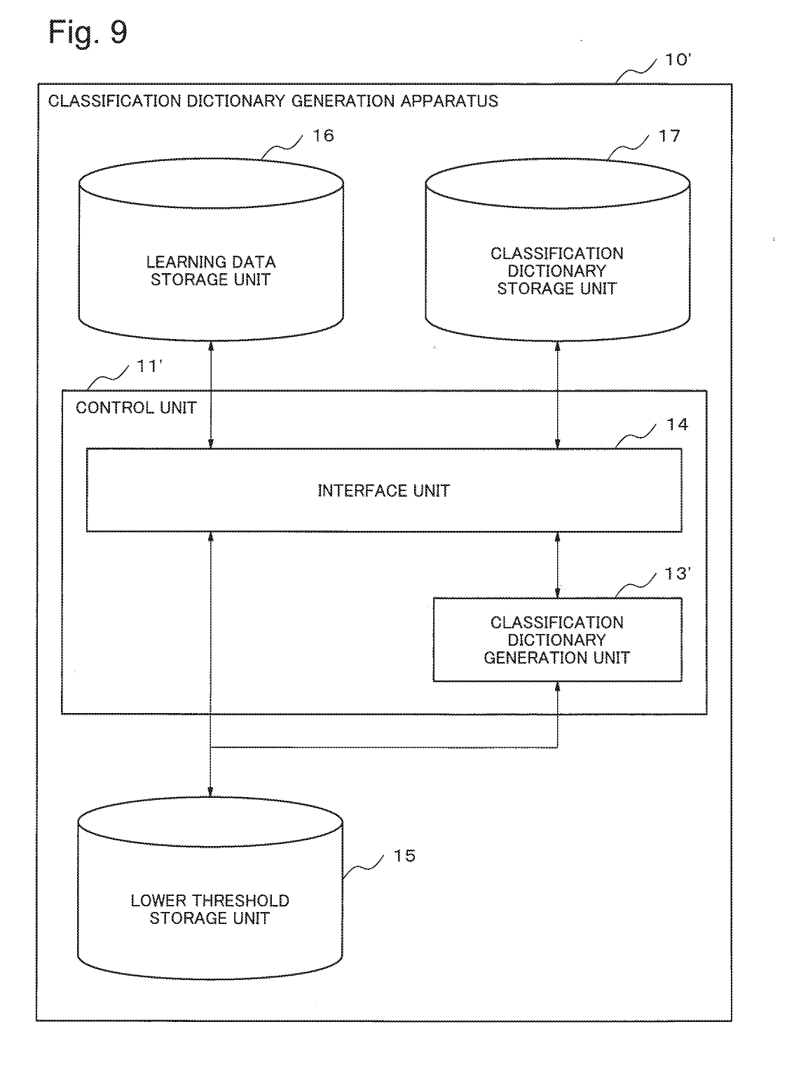

A second exemplary embodiment of the present invention will be explained in the following. FIG. 9 is a diagram illustrating an example of a configuration of a classification dictionary generation apparatus 10′ in the second exemplary embodiment of the present invention. In the second exemplary embodiment of the present invention, explanation on the configuration, which is the same as the configuration of the first exemplary embodiment of the present invention, is omitted.

According to the classification dictionary generation apparatus 10′ in the second exemplary embodiment of the present invention, a classification dictionary generation unit 13′ included in a control unit 11′ generates a classification dictionary based on the lower threshold information shown in FIG. 7.

Specifically, the present embodiment is a method that, correspondingly to a case that ID of the lower threshold information shown in FIG. 7 is (c), the classification dictionary generation unit 13′ sets a weight to have a lower limitation at a time of the machine learning as a constrained optimization problem.

While a logistic regression is exemplified as the machine learning in this example, the machine learning is not limited to the logistic regression. According to a basic logistic regression, the following Expression (1) is minimized with respect to the classification dictionary, that is, a weight vector w in this example. In Expression (1), i represents i'th document, and yᵢ is a variable which is equal to 1 in the case of the target category, and −1 in the case of the non-target category, and xᵢ is a feature vector. Moreover, w·xᵢ means an inner product of w and xᵢ.

$$\begin{matrix}[ Math 1 ] & \\ {\sum }_{i} log ( 1 + {e}^{- {y}_{i} w \cdot {x}_{i}} ) & ( 1 )\end{matrix}$$

As shown in the following Expression (2), it is possible to introduce a lower limitation to the logistic regression in the case of the constrained optimization problem in which each dimension of the weight vector is set to have the lower limitation, where wⱼ represents j'th dimensional value of the weight vector w, and α represents the lower threshold.

∀jα<wⱼ (α<0) (2)

In order to optimize the minimization of Expression (1) under the constraint of Expression (2), it is possible to use the optimization algorithm which can process the box constraint optimization, for example, L-BFGS-B or the like. In the case that ID of the lower threshold information is (c) as shown in FIG. 7, when a in Expression (2) is set to be −1.0 (lower threshold), the classification dictionary generation unit 13′ generates the classification dictionary which is specified by (c) shown in FIG. 8, that is, the classification dictionary of “KAKUNINN 1.5, KUDASAI 1.25, TANAKA −0.2, YAMADA −1.0, NEGAI −1.0, . . . . ” That is, the classification dictionary generation unit 13′ calculates the weight vector by carrying out the optimization as the constrained optimization problem whose constraints are the lower thresholds of the respective dimensional values of the weight vector, and generates the classification dictionary based on the calculated weight vector.

Accordingly, the classification dictionary generation apparatus 10′ in the second exemplary embodiment of the present invention carries out not generation of the classification dictionary which the classification dictionary generation apparatus 10 in the first exemplary embodiment of the present invention carries out by adjusting the learned discriminant function (weight vector) in the subsequent process (classification dictionary generation unit 13), but generation of the optimum classification dictionary at the time of learning. Accordingly, even if an amount of the information corresponding to the target category is less than an amount of the information corresponding to the non-target category, it is possible for the classification dictionary generation apparatus 10′ to generate the classification dictionary which calculates a score of the target category higher in comparison with the document not including information of the target category. Moreover, according to the classification dictionary generation apparatus 10′ in the second exemplary embodiment of the present invention, it is possible to reduce processing manhours in comparison with the classification dictionary generation apparatus 10 in the first exemplary embodiment of the present invention.

### Third Exemplary Embodiment

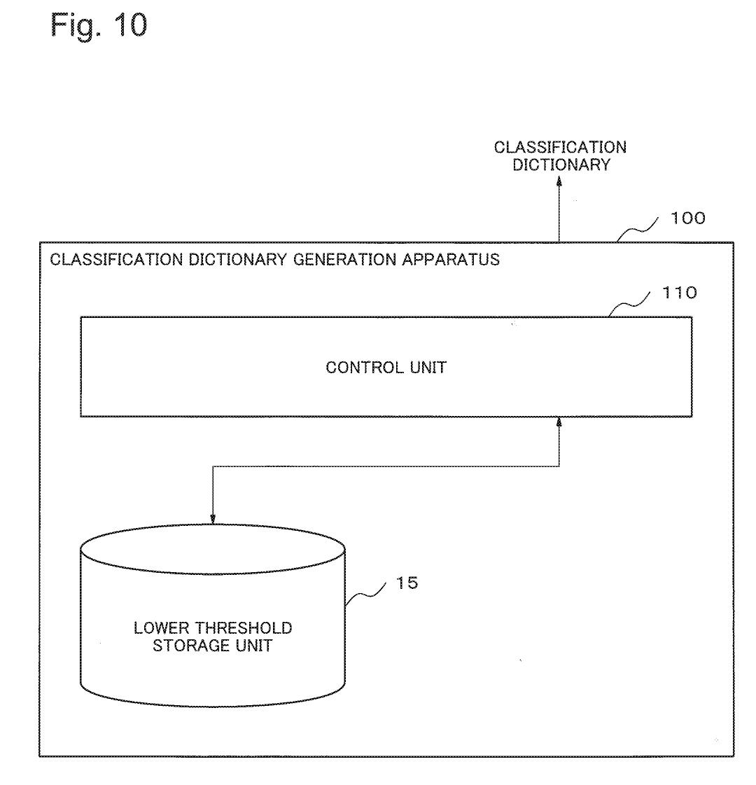

A third exemplary embodiment of the present invention will be explained in the following. FIG. 10 is a diagram illustrating an example of a configuration of a classification dictionary generation apparatus 100 in the third exemplary embodiment of the present invention. Here, in the third exemplary embodiment of the present invention, explanation on the configuration which is the same as the configuration of each exemplary embodiment is omitted.

The classification dictionary generation apparatus 100 in the third exemplary embodiment of the present invention includes the lower threshold storage unit 15 which stores lower threshold information for determining a lower threshold of a dimensional value of a classification dictionary for classifying a category of a document, and a control unit 110 which generates the classification dictionary based on learning data whose category is known.

Moreover, the control unit 110 generates, based on the lower threshold information stored in the lower threshold storage unit 15, the classification dictionary in which all of the dimensional values are equal to or larger than the lower threshold.

The classification dictionary generation apparatus 100, which includes the above-mentioned configuration, stores the lower threshold information for determining the lower threshold of the dimensional value of the classification dictionary for classifying the category of the document, and generates the classification dictionary based on the learning data whose category is known. At this time, the classification dictionary generation apparatus 100 generates the classification dictionary, in which all of the dimensional values are equal to or larger than the lower threshold, based on the stored lower threshold information. Accordingly, even if an amount of the information corresponding to the target category is less than an amount of the information corresponding to the non-target category, it is possible for the classification dictionary generation apparatus 100 to generate the classification dictionary which calculates a score of the target category higher in comparison with the document not including information of the target category.

In the third exemplary embodiment, the control unit 110 of the classification dictionary generation apparatus 100 may be a computer, and CPU (Central Processing Unit) (for example, CPU 1 in FIG. 2) or MPU (Micro-Processing Unit) of the computer may execute software (program) which realizes a function of each exemplary embodiment.

In the third exemplary embodiment of the present invention, the control unit 110 of the classification dictionary generation apparatus 100 stores, for example, the above-mentioned program in the storage device 3 shown in FIG. 2. The storage device 3 includes, for example, a computer-readable storage device such as a hard disc device, or various storage media such as CD-R (Compact Disc Recordable). The computer may acquire the software (program), which realizes the function of each exemplary embodiment, through a network.

The above-mentioned program of the classification dictionary generation apparatus 100 causes the computer to execute, at least, both of (1): a process of storing the lower threshold information for determining the lower threshold of the dimensional value of the classification dictionary for classifying the category of the document, and (2): a process of generating the classification dictionary based on the learning data whose category is known. Here, the process of generating the classification dictionary is a process of generating the classification dictionary, in which all of the dimensional values are equal to or larger than the lower threshold, based on the stored lower threshold information.

The computer of the classification dictionary generation apparatus 100 reads and executes a program code of the acquired software (program). Accordingly, the classification dictionary generation apparatus 100 may carry out a process which is the same as the process of the classification dictionary generation apparatus according to each of the exemplary embodiments.

While the invention has been particularly shown and described with reference to exemplary embodiments thereof, the invention is not limited to these embodiments. It will be understood by those of ordinary skill in the art that various changes in form and details may be made therein without departing from the scope of the present invention.

This application is based upon and claims the benefit of priority from Japanese Patent Application No. 2013-192674, filed on Sep. 18, 2013, the disclosure of which is incorporated herein in its entirety by reference.

### REFERENCE SIGNS LIST

1 CPU
2 RAM
3 storage device
4 communication interface
5 input device
6 output device
10 classification dictionary generation apparatus
10′ classification dictionary generation apparatus
11 control unit
11′ control unit
12 discriminant function calculation unit
13 classification dictionary generation unit
13′ classification dictionary generation unit
14 interface unit
15 lower threshold storage unit
16 learning data storage unit
17 classification dictionary storage unit
100 classification dictionary generation apparatus
110 control unit

What is claimed is:

1. A classification dictionary generation apparatus, comprising:
a lower threshold storage unit configured to store lower threshold information that determines a lower threshold of dimensional values of a classification dictionary for classifying a category of a document; and
a control unit configured to generate the classification dictionary based on learning data whose category is known,
wherein the control unit generates, based on the lower threshold information stored in the lower threshold storage unit, the classification dictionary in which all of the dimensional values are equal to or larger than the lower threshold.

2. The classification dictionary generation apparatus according to claim 1,
wherein the learning data includes a set of documents to each of which category information is assigned, and
wherein the control unit extracts features, which reflect contents of each document included in the set of documents, from each document, calculates a feature vector, and generates the classification dictionary in which, out of the dimensional values of the classification dictionary, the dimensional value corresponding to a non-target category is equal to or larger than the lower threshold.

3. The classification dictionary generation apparatus according to claim 1, further comprising a discriminant function calculation unit configured to calculate a discriminant function based on the learning data,
wherein the control unit generates the classification dictionary based on the discriminant function calculated by the discriminant function calculation unit and the lower threshold information stored in the lower threshold storage unit.

4. The classification dictionary generation apparatus according to claim 3,
wherein the lower threshold storage unit stores lower threshold information whose lower threshold equal to a dimensional value of the discrimination function, the dimensional value of the discrimination function being one of dimensional values of the discrimination function and being smaller than the lower threshold determined in advance.

5. The classification dictionary generation apparatus according to claim 3,
wherein the lower threshold information storage unit stores lower threshold information that determines a lower threshold by multiplying a minimum value of the dimensional values of the discriminant function by a predetermined ratio that is larger than 0 and smaller than 1 and sets this lower threshold as a value of the discriminant function.

6. The classification dictionary generation apparatus according to claim 1, further comprising:
a learning data storage unit configured to store the learning data; and
a classification dictionary storage unit configured to store the classification dictionary,
wherein the control unit writes the classification dictionary in the classification dictionary storage unit.

7. The classification dictionary generation apparatus according to claim 1,
wherein the control unit calculates a weight vector by carrying out optimization as a constrained optimization problem whose constraints are lower thresholds of respective dimensional values of the weight vector, and generates the classification dictionary based on the weight vector calculated.

8. The classification dictionary generation apparatus according to claim 3,
wherein the discriminant function calculation unit calculates the discriminant function using at least one of a word, a phrase including a plurality of words, a clause, a character substring, and a modification relation among two or more words or clauses that appear in a document, as the features.

9. A classification dictionary generation method, comprising:
storing lower threshold information that determines a lower threshold of dimensional values of a classification dictionary for classifying a category of a document; and
generating the classification dictionary, in which all of the dimensional values are equal to or larger than the lower threshold, based on learning data whose category is known, and the lower threshold information stored.

10. A non-transitory computer-readable recording medium recording a program for causing a computer to execute:
a process of storing lower threshold information that determines a lower threshold of dimensional values of a classification dictionary for classifying a category of a document; and
a process of generating the classification dictionary based on learning data whose category is known,
wherein the process of generating the classification dictionary is a process of generating the classification dictionary, in which all of the dimensional values are equal to or larger than the lower threshold, based on the lower threshold information stored.
